(19) United States
(12) Patent Application Publication
(10) Pub. No.: US 2017/0080879 A1
(43) Pub. Date: Mar. 23, 2017

(54) BLOW MOLDED LOAD FLOORS

(71) Applicant: FORD GLOBAL TECHNOLOGIES, LLC, Dearborn, MI (US)

(72) Inventor: Raj S. Roychoudhury, Bloomfield Hills, MI (US)

(21) Appl. No.: 14/857,968

(22) Filed: Sep. 18, 2015

(51) Int. Cl. B60R 13/01; B29C 49/20; B32B 7/04; B32B 5/02; D05C 17/02; B32B 3/08

(52) U.S. Cl. CPC B60R 13/011; D05C 17/02; B32B 3/085; B32B 7/04; B32B 5/02; B29C 49/20; B60R 2013/015; B60R 2013/018; B32B 2250/04; B32B 2605/08; B29C 2049/203; B29L 2031/3017

(57) ABSTRACT

A load floor for a vehicle includes a carpet having a tuft attached to a backing, a plurality of inserts attached to a second side of the backing, a top surface fused to the carpet and encapsulating the inserts, and a bottom surface fused to the encapsulated inserts. The inserts may be varied in material, shape, thickness, and spacing to provide a tunable stiffness. A related method includes forming a parison feeding the parison between mold halves shaped like a load floor, hanging a carpet and a plurality of inserts in the first mold half, clamping the parison by moving the mold halves together to form a mold, and pushing the parison outward, using blown air, such that the parison is adjacent the backing in the first mold forming a top surface and encapsulating the inserts, and adjacent the second mold half forming a bottom surface fused to the parison encapsulating the inserts.

### TECHNICAL FIELD

This document relates generally to load floors, and more specifically to a load floor used within a vehicle.

### BACKGROUND

Load floors are commonly utilized in an automotive setting as, among other uses, spare tire covers, package shelves, cargo management systems, running boards with and without non-skid surfaces, seat back structures, engine belly pans, and battery trays. More generally, load floors may be utilized as structural flat parts in non-automotive settings. Current load floors are produced by many methods. These methods, however, suffer from certain drawbacks including excessive weight, excessive thickness, being non-recyclable, and/or over expensive to manufacture, including tooling costs. Even more, these load floor often require the use of additives, do not offer localized stiffness tuning, and are adverse to variations in both shape, height and thickness.

Accordingly, a need exists for a load floor that is lightweight, thin, inexpensive and recyclable. These attributes assist in keeping the mass low, decreasing packing space, and helping the environment. Even more, the load floor should provide a stiffer structure with a tunable bending stiffness and allow for variations in thickness, provide cavities for storage, and be reversible. Such load floors having increased structural rigidity (E×I) may be developed by increasing the stiffness on the outer layers of the load floor where E=a material elastic modulus and I=section moment of area. In one dimension, i.e., for a beam, the optimum solution is in the form of an I-beam. In two dimensions, i.e., for a plate, an optimum solution is in the form of two stiff plates separated by an incompressible lightweight material. Such a structure can be created using a blow mold process.

This document relates to parts used in a vehicle including a load floor that is manufactured in a blow mold process to form a lightweight, unitary, and structurally significant piece that minimizes mass, packing space, and negative environmental impact. The load floor also provides a stiffer structure with a tunable bending stiffness. Even more, the stiffness is tunable by altering inserts within the load floor without changing the molds. For instance, the thickness, material properties, spacing, and/or shape (e.g., linear or non-linear) of the inserts can be varied without touching the molds.

### SUMMARY

In accordance with the purposes and benefits described herein, a load floor for a vehicle is provided. The load floor may be broadly described as including a carpet having a tuft attached to a first side of a backing, a plurality of inserts attached to a second side of the backing, a top surface fused to the second side of the carpet and encapsulating the plurality of inserts, and a bottom surface fused to the encapsulated inserts.

In another possible embodiment, the top surface is thinner than the bottom surface.

In still another possible embodiment, a second carpet includes a tuft attached to a first side of a backing, wherein the bottom surface is fused to a second side of the backing of the second carpet along a first side of the bottom surface and to the encapsulated inserts along a second side of the bottom surface.

In yet another possible embodiment, the plurality of inserts may be a paper, a paper core, a reinforced plastic, a recycled plastic, and/or a metal.

In another possible embodiment, the at least a portion of the plurality of inserts are non-linear. In still another, the spacing between the plurality of inserts varies from one portion of the load floor to a second portion of the load floor. In another, a height of at least one insert of the plurality of inserts varies from a height of at least one other insert of the plurality of inserts, and the bottom surface is non-planar. In yet still another possible embodiment, a height of at least one insert of the plurality of inserts varies along a length of the at least one insert, and the bottom surface is non-planar.

In still another possible embodiment, the load floor further includes a reinforcement mat between the carpet and the top surface. In this embodiment, a first side of the reinforcement mat is bonded to the second side of the backing, the plurality of inserts are attached to a second side of the reinforcement mat, and the top surface is fused to the second side of the reinforcement mat and encapsulates the plurality of inserts.

In one other embodiment, a load floor includes an outer surface having a plurality of inserts attached to a first side, a top surface fused to the first side of the outer surface and encapsulating the plurality of inserts, and a bottom surface fused to the encapsulated inserts.

In another possible embodiment, the end portions of the plurality of inserts extend above the top surface.

In yet another possible embodiment, the load floor further includes an outer surface, wherein the plurality of inserts are attached to a first side of the outer surface and fully encapsulated by the outer surface and the top surface, and the top surface is fused to the first side of the outer surface.

In another possible embodiment, the bottom surface includes a plurality of raised ribs.

In yet still another possible embodiment, at least a portion of the plurality of inserts are non-linear.

In still another possible embodiment, a distance between each of the plurality of inserts varies from one portion of the load floor to a second portion of the load floor.

In another possible embodiment, a height of at least one insert of the plurality of inserts varies from a height of at least one other insert of the plurality of inserts, and the bottom surface is non-planar. In still another possible embodiment, a height of at least one insert of the plurality of inserts varies along a length of the at least one insert, and the bottom surface is non-planar.

In other possible embodiments, the load floors described above are incorporated into a vehicle.

In accordance with another aspect, a method of forming a load floor for a vehicle is provided. The method may be broadly described as comprising the steps of: (a) forming a parison, feeding the parison between a first mold half and a second mold half, the first and second mold halves shaped like the load floor, hanging a carpet having a tuft attached to a first side of a backing and a plurality of inserts attached to a second side of the backing in the first mold half, clamping the parison by moving the first and second mold halves together to form a mold, and pushing the heated parison outward, using blown air, such that the heated parison is adjacent the second side of the backing in the first mold forming a top surface and encapsulating the plurality of inserts, and adjacent the second mold half forming a bottom surface fused to a portion of the parison encapsulating the plurality of inserts.

In another possible embodiment, the method may further include the step of tuning a stiffness of the load floor by varying at least one of a spacing between the plurality of inserts, a thickness of the plurality of inserts, and/or material of the plurality of inserts.

In the following description, there are shown and described several preferred embodiments of the load floor and the related methods. As it should be realized, the load floor and methods are capable of other, different embodiments and their several details are capable of modification in various, obvious aspects all without departing from the assemblies and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the load floor and together with the description serve to explain certain principles thereof. In the drawing figures:

FIG. 1 is a partial cross-sectional side view of a load floor having a plurality of encapsulated inserts and a carpet layer;

FIG. 2 is a partial cross-sectional side view of a reversible load floor having a plurality of encapsulated inserts, a carpet layer, and raised ribs;

FIG. 3 is a partial cross-sectional side view of a load floor having a plurality of encapsulated inserts and first and second carpet layers;

FIG. 4 is a partial cross-sectional side view of a load floor as shown in FIG. 1 with a reinforcement mat positioned between an upper layer and the carpet layer;

FIG. 5 is a cross-sectional top view showing a load floor and, in particular, non-linear inserts;

FIG. 6 is a cross-sectional top view showing a load floor and, in particular, varied spacing between inserts in differing portions of the load floor;

FIG. 7 is a cross-sectional end view showing a load floor and, in particular, inserts of varying heights resulting in a non-planar lower surface;

FIG. 8 is a cross-sectional side view showing a load floor and, in particular, inserts having varying heights along a length of the inserts;

FIG. 9 is a cross-sectional view of closing mold halves for forming a load floor having a parison positioned therebetween;

FIG. 10 is a cross-sectional view of a mold formed by mold halves showing a parison pushed outward by a fluid;

FIG. 11 is a cross-sectional view of opening mold halves releasing a formed load floor;

FIG. 12 is a cross-sectional illustration of a heated parison being forced outward by a fluid and stretching around an insert; and

FIG. 13 is a cross-section illustration of an in-mold load floor formed by fluid forcing the heated parison outward against the backing of the carpet and a mold half, and encapsulating the insert.

Reference will now be made in detail to the present embodiments of the load floor and the related methods, examples of which are illustrated in the accompanying drawing figures, wherein like numerals are used to represent like elements.

### DETAILED DESCRIPTION

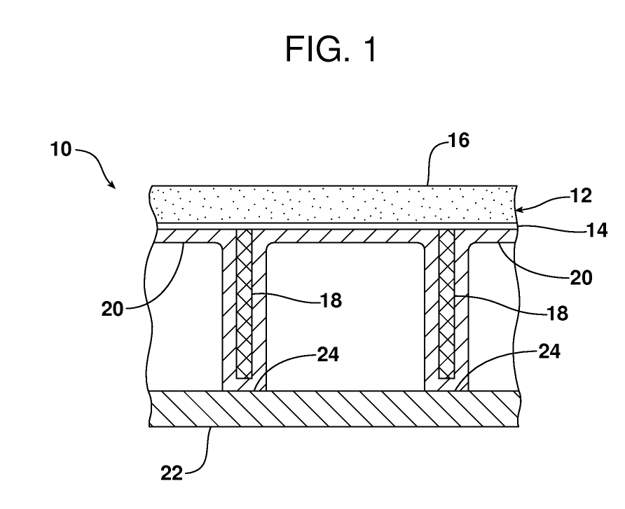

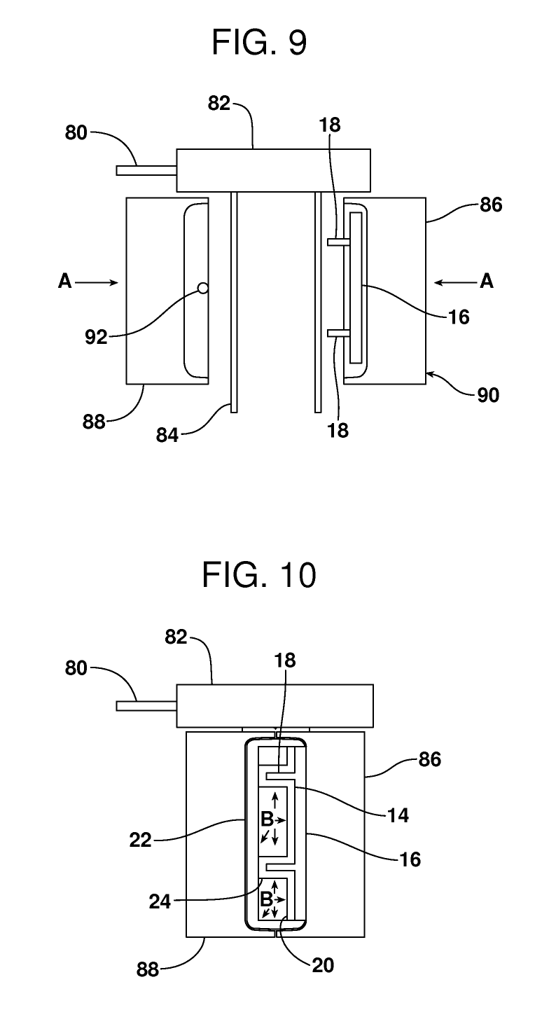

Reference is now made to FIG. 1 which illustrates an embodiment of a load floor 10. In the described embodiment, the load floor 10 is intended for use in a vehicle. The load floor 10 and various embodiments thereof may also be used in non-vehicle settings including, for example, as structural flat parts. The load floor 10 in the described embodiment includes a carpet layer 12 having a backing 14 and a tuft 16 attached to and extending from a first side of the backing 14. A plurality of inserts 18, or ribs, are attached to a second side of the backing 14 prior to occurrence of the blow molding process described below. In fact, the carpet layer 12 and attached plurality of inserts 18 are positioned within a first mold half 86 prior to formation of the load floor 10 as best shown in FIG. 9.

A top surface 20 in the described embodiment is a plastic (e.g., polypropylene). The plastic is in pellet form prior to heating and extruding to form a parison in a blow molding machine. The heated parison is fed between first and second mold halves 86, 88 and pushed outward using blown air. As the heated parison is pushed outward, the heated parison is forced adjacent a second side of the backing 14 in the first mold half 86 forming the top surface 20 and encapsulating the plurality of inserts 18. The heated parison is further pushed outward and is forced against the second mold half 88 forming a bottom surface 22. During the molding process, a first surface of the bottom surface 22 fuses to portions 24 of the parison encapsulating the plurality of inserts 18.

Alternate embodiments may exclude the carpet layer 12. In one such embodiment, the plurality of inserts are positioned within the mold half 86 and the heated parison is forced against the mold forming the top surface. In this embodiment, the plurality of inserts extend above the top surface 20 formed by the blow molding process forming an anti-slip or a non-skid surface. In other embodiments, the plurality of inserts may be attached to an outer surface formed by injection molding or other methods. The outer surface may include slit protrusions, for example, such that any type of insert can be attached to the outer surface in any orientation and/or spacing. In this embodiment, the outer surface and plurality of inserts are positioned within the mold half 86 and the heated parison is forced against a first side of the outer surface. The heated parison is fused to the first side of the outer surface forming the top surface and again encapsulating the plurality of inserts.

In the described embodiment, the plurality of inserts 18 are paper cores. In alternate embodiments, the plurality of inserts 18 may be made of other forms of paper, plastics or metals, recycled paper, plastics or metals, or combinations thereof. For example, first and third portions of the plurality of inserts 18 may be paper core while a second, middle, portion is recycled metal. The material chosen for use as the plurality of inserts 18 is dependent upon the particular application for the load floor.

As shown in FIG. 1, the top surface 20 in the described embodiment is thinner than the bottom surface 22. Under loading conditions, a top surface of a load floor is in compression and a bottom surface is in tension. Plastics, and materials in general, can carry more load in compression than in tension. Thus, a load floor structure is more efficient, with respect to mass, if the top surface is thinner than the bottom surface. Of course, alternate embodiments may have top and bottom surfaces of the same thickness or even a reversed situation wherein the top surface is thicker than the bottom surface. Even more, the alternate embodiment wherein the load floor includes an outer surface in lieu of the carpet layer may be designed such that a combined thickness of the outer surface and the top surface is less than a thickness of the bottom surface, or otherwise.

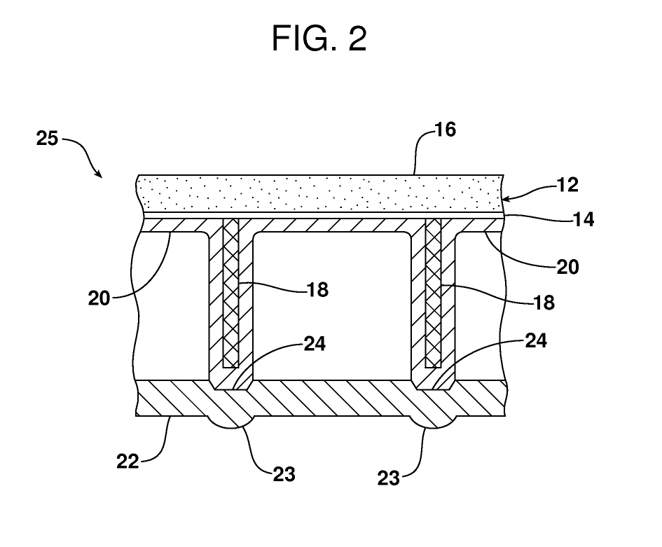

In the embodiment shown in FIG. 1, the bottom surface 22 of the load floor 10 is flat allowing the load floor to be reversible. In an alternate embodiment shown in FIG. 2, the bottom surface 22 of a reversible load floor 25 may include raised ribs 23. In this embodiment, objects are easily slid across the bottom surface 22 due to the ribs 23 and/or wet or damp objects may be positioned on the load floor 25 allowing air to reach all surfaces of the object.

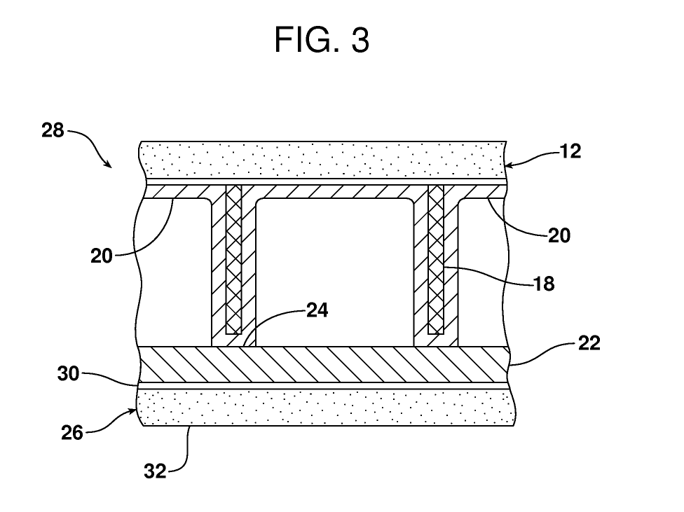

In another alternate embodiment shown in FIG. 3, a second carpet layer 26 is added to the load floor 10 forming a reversible load floor 28 having outward facing carpet layers 12, 26. As with the first carpet layer 12, the second carpet layer 26 includes a backing 30 and a tuft 32 attached to and extending from a second side of the bottom surface 22. As with the first carpet layer 12, the second carpet layer 26 is positioned within a second mold half 88 prior to occurrence of the blow molding process described below and fuses to the backing 30 of the second carpet layer 26.

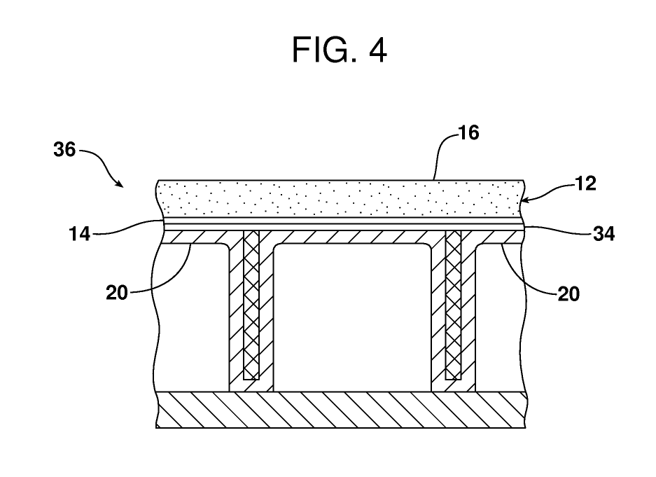

In yet another alternate embodiment shown in FIG. 4, a reinforcement mat 34 is positioned between the carpet layer 12 and the top surface 20 forming a reinforced load floor 36. More specifically, a first side of the reinforcement mat 34 is adhered to the second side of the backing 14 and the plurality of inserts 18 are attached to a second side of the reinforcement mat 34 prior to occurrence of the blow molding process described below. In fact, the carpet layer 12, reinforcement mat 34, and attached plurality of inserts 18 are all positioned within the first mold half prior to formation of the load floor 36. In additional embodiments, the reinforced load floor 36 may be reversible and may include a second carpet layer as described above with respect to load floor. In such embodiments, a reinforcement mat may be positioned between the second carpet layer and a bottom surface of the load floor, or two reinforcement mats may be added adjacent each carpet later.

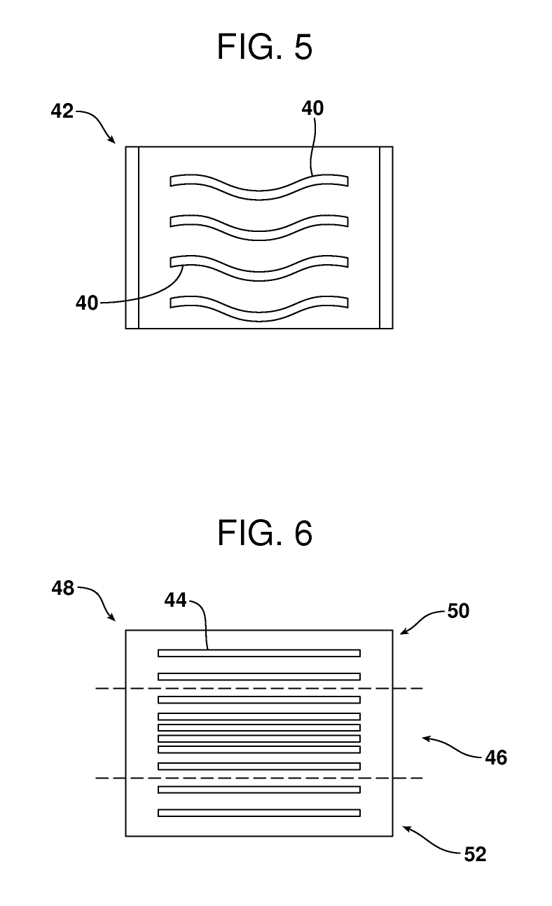

In addition to varying the material used for the plurality of inserts, the plurality of inserts may further be varied in alternate embodiments to tune the stiffness of the load floor. As shown in FIG. 5, for example, a plurality of inserts 40 of a load floor 42 may be non-linear (depicted as wavy in the FIG. 5 embodiment). In such embodiments, all of the plurality of inserts 40 may be non-linear or a portion, or portions, of the plurality of inserts 40 may be non-linear with another portion or portions being linear.

Even more, spacing between the plurality of inserts may vary from one portion to another. As shown in FIG. 6, spacing between a plurality of inserts 44 (shown linear) may be narrower in a central portion 46 of a load floor 48 than in outer portions 50, 52 of the load floor. Such narrower spacing is effectively adding inserts to the plurality of inserts within a localized area, i.e., the central portion 46 of the load floor 48. Of course, in alternate embodiments, the spacing may vary within any number of portions of the load floor depending on the application and load bearing requirements of the various portions of the load floor and the spacing may vary for non-linear and linear inserts alike.

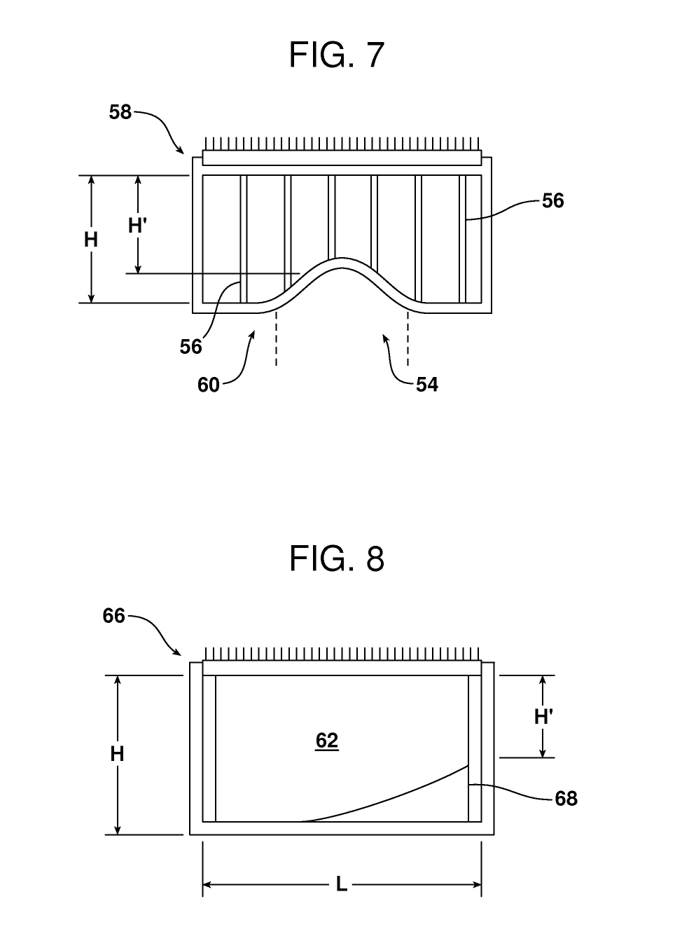

As shown in FIG. 7, a height (designated H′) of a portion 54 of a plurality of inserts 56 of a load floor 58 may vary from a height (designated H) of another portion 60 of the plurality of inserts. The height may be varied in this manner forming a non-planar bottom surface to accommodate a specific contour of a support surface (not shown) upon which the load floor 58 rests. Even more, a multitude of varying heights of individual inserts or portions of inserts of the plurality of inserts 56 may be utilized in alternate embodiments. As discussed above, spacing between the plurality of inserts 56 or portions thereof and the shape (linear vs. non-linear) of the plurality of inserts or portions thereof may vary in alternate embodiments.

Even more, a height of at least one insert 62 of a plurality of inserts of a load floor 66 may vary along a length (L) of the at least one insert. As shown in FIG. 8, a height (H) of insert 62 varies from a maximum H to a minimum H′ along its length (L). A height of a second insert 68 remains unvaried along a length of the second insert but the height is different than the height of the insert 62 at least along a portion of the inserts. Again, the height may be varied in this manner forming a non-planar bottom surface to accommodate a specific contour of a support surface (not shown) upon which the load floor 66 rests. Even more, a multitude of varying heights of individual inserts or portions of inserts of the plurality of inserts 56 may be utilized in alternate embodiments. As discussed above, spacing between the plurality of inserts 62 or portions thereof and the shape (linear vs. non-linear) of the plurality of inserts or portions thereof may vary in alternate embodiments.

As generally indicated above, the load floor 10 in the described embodiment is made utilizing a blow molding process as shown in FIGS. 9 through 11. Plastic pellets are melted in a melting chamber of an extruder (not shown) prior to being fed as a melted plastic 80 to an extrusion head 82. A parison 84 which is generally described as a tubular shape of hot plastic is formed by the extrusion head 82 and extends between first and second mold halves 86, 88. As the parison 84 extends from the extrusion head 82 the length of the mold 90, the first and second mold halves 86, 88 come together, as shown by action arrows A, to form the load floor mold and clamp the parison 84 in position. Fluid is introduced into the mold 90 through an opening in tube 92. In the described embodiment, the carpet layer 12 and attached plurality of inserts 18 are positioned within a first mold half 86 prior to closing the first and second mold halves 86, 88. For clarity, only two inserts are shown in the figures.

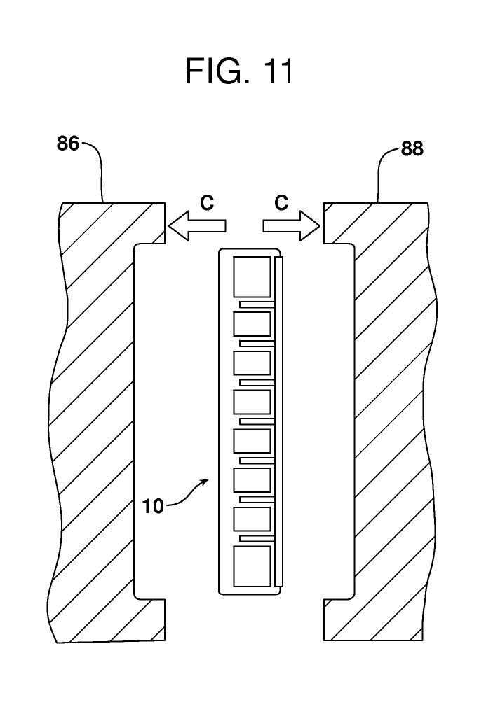

As shown in FIG. 10, fluid is introduced into the mold 90 through blow pin 92 as shown by action arrows B. In the described embodiment, the fluid is ambient air which pushes the heated parison 84 outward. As the heated parison 84 is pushed outward, the parison is forced adjacent a second side of the backing 14 in the first mold half 86 forming the top surface 20 and encapsulating the plurality of inserts 18. The heated parison is further pushed outward and is forced against the second mold half 88 forming a bottom surface 22. During the molding process, a first surface of the bottom surface 22 fuses to portions 24 of the parison encapsulating the plurality of inserts 18. Once the top surface 20 and bottom surface 22 have cooled and hardened, the first and second mold halves 86, 88 are opened as shown by action arrows C in FIG. 11 and the load floor 10 is ejected.

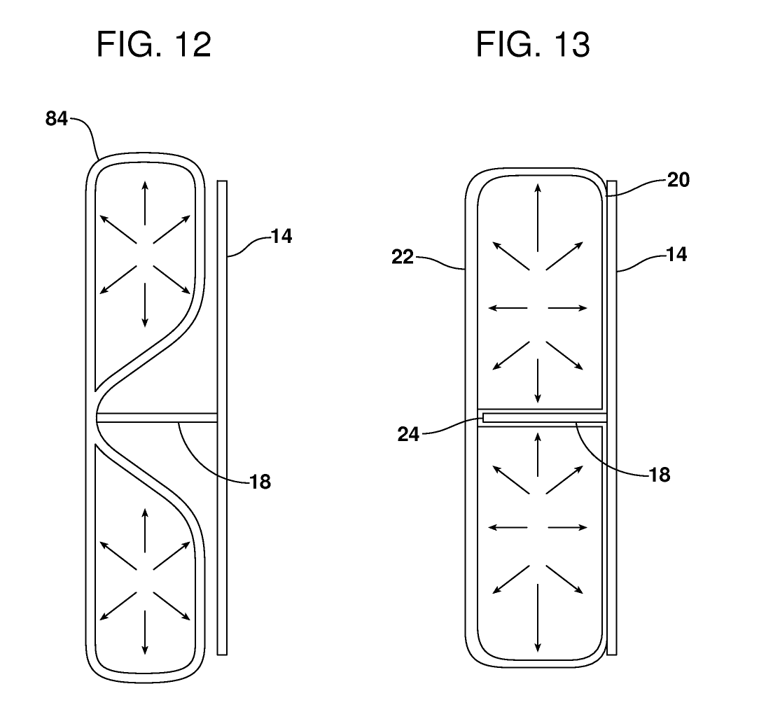

As indicated above, the top surface 20 in the described embodiment is thinner than the bottom surface 22. As shown in FIGS. 12 and 13, as the fluid pushes the heated parison 84 outward, the parison is stretched by the plurality of inserts 18 causing a thinning of the surface which is forced adjacent the second side of the backing 14 forming the top surface 20 and encapsulating the plurality of inserts. Once the heated parison 84 contacts a surface of the mold 90, the plurality of inserts 18, and/or the second side of the backing 14, the parison adheres to the surface and ceases to stretch. As shown, the resulting top surface 20 is thinner than the resulting bottom surface 22.

In summary, numerous benefits result from providing a load floor formed as described above. Forming the load floor in accordance with the described method provides for a load floor that is lightweight, thin, inexpensive and recyclable. These attributes assist in keeping the mass low, decreasing packing space, and helping the environment, and provide a stiffer structure with a tunable bending stiffness. Advantageously, the stiffness is tunable by altering inserts within the load floor without changing the molds. For instance, the thickness, material properties, spacing, and/or shape (e.g., linear or non-linear) of the inserts can be varied without touching the molds. Even more, the load floor allows for variations in thickness, provides cavities for storage, and is reversible, if desired.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A load floor for a vehicle, comprising:
a carpet having a tuft attached to a first side of a backing;
a plurality of inserts attached to a second side of said backing;
a top surface fused to said second side of said carpet and encapsulating said plurality of inserts; and
a bottom surface fused to said encapsulated inserts.

2. The load floor for a vehicle of claim 1, wherein said top surface is thinner than said bottom surface.

3. The load floor for a vehicle of claim 1, further comprising a second carpet having a tuft attached to a first side of a backing, wherein said bottom surface is fused to a second side of said backing of said second carpet along a first side of said bottom surface and to said encapsulated inserts along a second side of said bottom surface.

4. The load floor for a vehicle claim 1, wherein each of said plurality of inserts is a paper, a paper core, a reinforced plastic, a recycled plastic, or a metal.

5. The load floor for a vehicle of claim 1, wherein at least a portion of said plurality of inserts are non-linear.

6. The load floor for a vehicle of claim 1, wherein spacing between said plurality of inserts varies from one portion of the load floor to a second portion of the load floor.

7. The load floor for a vehicle of claim 1, wherein a height of at least one insert of said plurality of inserts varies from a height of at least one other insert of said plurality of inserts, and said bottom surface is non-planar.

8. The load floor for a vehicle of claim 1, wherein a height of at least one insert of said plurality of inserts varies along a length of said at least one insert, and said bottom surface is non-planar.

9. The load floor for a vehicle of claim 1, further comprising a reinforcement mat between said carpet and said top surface, wherein a first side of said reinforcement mat is bonded to said second side of said backing, said plurality of inserts are attached to a second side of said reinforcement mat, and said top surface is fused to said second side of said reinforcement mat and encapsulates said plurality of inserts.

10. A load floor, comprising:
a plurality of inserts;
a top surface at least partially encapsulating said plurality of inserts; and
a bottom surface fused to said top surface and said encapsulated inserts.

11. The load floor of claim 10, wherein end portions of said plurality of inserts extend above said top surface.

12. The load floor of claim 10, further comprising an outer surface, wherein said plurality of inserts are attached to a first side of said outer surface and fully encapsulated by said outer surface and said top surface, and said top surface is fused to said first side of said outer surface.

13. The load floor of claim 12, wherein said bottom surface includes a plurality of raised ribs.

14. The load floor of claim 10, wherein at least a portion of said plurality of inserts are non-linear.

15. The load floor of claim 10, wherein a distance between each of said plurality of inserts varies from one portion of the load floor to a second portion of the load floor.

16. The load floor of claim 10, wherein a height of at least one insert of said plurality of inserts varies from a height of at least one other insert of said plurality of inserts.

17. The load floor of claim 10, wherein a height of at least one insert of said plurality of inserts varies along a length of said at least one insert.

18. A vehicle incorporating the load floor of claim 10.

19. A method of forming a load floor of a vehicle comprising the steps of:
forming a parison;
feeding said parison between a first mold half and a second mold half, said first and second mold halves shaped like the load floor;
hanging a carpet having a tuft attached to a first side of a backing and a plurality of inserts attached to a second side of said backing in said first mold half;
clamping said parison by moving said first and second mold halves together to form a mold; and
pushing said heated parison outward, using blown air, such that said heated parison is adjacent said second side of said backing in said first mold forming a top surface and encapsulating said plurality of inserts, and adjacent said second mold half forming a bottom surface fused to a portion of said parison encapsulating said plurality of inserts.

20. The method of forming a load floor a vehicle of claim 19, further comprising the step of tuning a stiffness of said load floor by varying at least one of a spacing between said plurality of inserts, a thickness of said plurality of inserts, a shape of said plurality of inserts, and/or a material of said plurality of inserts.
